(19) United States
(12) Patent Application Publication
(10) Pub. No.: US 2011/0047083 A1
(43) Pub. Date: Feb. 24, 2011

(54) COMPUTER SYSTEM AND METHOD FOR NEGOTIATING A PRICE OF A RENTAL PROPERTY

(76) Inventor: Rebecca J. Lawler, Malvern, PA (US)

Correspondence Address: Mark R. Malek;Zies Widerman & Malek, 202 N. Harbor City Boulevard, Suite 101, Melbourne, FL, 32935, US

(21) Appl. No.: 12/851,937

(22) Filed: Aug. 6, 2010

Related U.S. Application Data
(60) Provisional application No. 61/234,769, filed on Aug. 18, 2009.

(51) Int. Cl. G06Q 99/00

(52) U.S. Cl. 705/80; 705/39

(57) ABSTRACT

A system for negotiating pricing for a rental property includes a first client device in communication with a global communications network to be used by a prospective leasee of the rental property and a second client device in communication with the global communications network to be used by a leasor of the rental property. The system also includes a server in communication with the first and second client devices via the global communications network, and a database stored on a memory of the server having information stored thereon. The server is adapted to receive information from the first and second client devices to be stored on the database and to be transmitted between the first and second client devices via the global communications network. The server is also adapted to compare the information transmitted by the first and second client devices with the information stored on the database, and provide an indication of compatibility or non-compatibility of the information with the information stored on the database.

### RELATED APPLICATIONS

This application claims the benefit of U.S. Provisional Patent Application Ser. No. 61/234,769 titled COMPUTER SYSTEM AND METHOD FOR NEGOTIATING A PRICE OF A RENTAL PROPERTY filed on Aug. 18, 2009, by the inventor of the present application, the entire contents of which are incorporated herein by reference.

### FIELD OF THE INVENTION

The present invention relates to the field of rental properties and, more specifically, relates to the field of computer systems for negotiating rental property prices.

### BACKGROUND OF THE INVENTION

When a prospective renter is searching for a rental property, it is desirable to have several options available and to list those options based on certain criteria. This type of searching is available, for example, using several different types of search engines. One such search engine, for example, is Rentals.com. This particular search engine offers the ability of a prospective renter to search for rental properties based on availability, price, location, and other factors. This search engine also allows a user to list the located properties based on various factors, i.e., rental price, availability, size, etc. One issue with such a search engine is that it only provides a user with a fixed price that the rental property is being offered for. In order to even attempt to obtain a lower price, the user is generally required to contact the landlord directly in order to submit a proposed price. Other known search engines for locating rental properties include, for example, rent.com, 4walls.us, forrent.com, apartmentguide.com, apartments.com, apartmentshowcase.com, apartmenthomeliving.com, move.com, mynewplace.com, and apartmentsearch.com.

In an attempt to solve this problem, a search site located at therentnegotiator.com provides an area that allows prospective renters to hire a person to negotiate a lower rent for them. For example, if a prospective renter has located a rental property that they desire to rent, the prospective renter may hire a person via therentnegotiator.com to engage in a negotiation process on their behalf. This type of system, however, may not be productive as it merely has included a “middle man” into the process, i.e., one more person being involved in what may sometimes be an already complicated process.

Some services exist that assist prospective leasees and perspective leasors come to an agreement as to pricing and selection of rental property. For example, U.S. Pat. No. 7,024,397 to Donahue discloses a system that facilitates a structured lease negotiation between two parties to a real estate transaction. A series of predefined milestone negotiation steps are executed on a computer that couples two parties through a network. A web browser is used to answer predefined questions regarding the proposed transaction between the prospective leasee and the prospective leasor in a manner that allows for some of the aspects of the transaction to be accomplished prior to finalizing the transaction offline.

There have been some systems available that allow consumers to attempt to negotiate pricing for various goods and services. For example, U.S. Pat. No. 6,085,169 to Walker et al. discloses a conditional purchase management system that receives offers from a customer, evaluates the received offer against a set of rules and makes a determination of whether the seller is willing to accept the offer. This system has been in place on such sites as priceline.com. The '169 patent is directed towards airline tickets and hotel reservations, for example. Further, it is known to provide on-line auction sites, such as eBay.com, that may offer real estate.

Accordingly, there exists a need to provide a way for a consumer to search, locate and negotiate a price for a rental property online.

### SUMMARY OF THE INVENTION

With the above in mind it is therefore an object of the present invention to provide a system for negotiating pricing for a rental property that is simple to use and that allows for enhanced flexibility of both a leasor of the rental property and a prospective leasee of the rental property. It is also an object of the present invention to provide a system that allows for a leasor of rental property to readily lease rental property that remains unleased. It is further an object of the present invention to provide a system that minimizes the necessity of sales calls and contacts between a leasor and a leasee, and that preserves the anonymity of the leasee from the leasor until after the negotiation process is completed.

These and other objects, features, and advantages according to the present invention are provided by a system for negotiating pricing of rental property including a first client device in communication with a global communications network to be used by a prospective leasee of the rental property. The system also includes a second client device in communication with the global communications network to be used by a leasor of the rental property. The system further includes a server in communication with the first and second client devices via the global communications network, and a database stored on a memory of the server.

The database may include a memory having information stored thereon. The information may relate to attributes of the rental property, attributes of the prospective leasee of the rental property, and attributes of the perspective leasor of the rental property. The server may be adapted to receive information from the first and second client devices to be stored on the database and to be transmitted between the first and second client devices via the global communications network. The server may also be adapted to compare the information transmitted by the first and second client devices with the information stored on the database, and provide an indication of compatibility or non-compatibility of the information transmitted by the first and second client devices with the information stored on the database.

The information stored on the database may be a minimum lease amount that the leasor of the rental property is willing to accept. In such an embodiment, the information transmitted by the first client device may be an offer of a lease amount for the rental property. Compatibility of the information may be defined by the offer of the lease amount being equal to or exceeding the minimum lease amount. Compatibility of the information may also be defined by the lease amount being within a predetermined percentage of the minimum lease amount for the rental property. Upon receiving an offer of a lease amount for the rental property, the server may provide an indication to the second client device that an offer of the lease amount has been transmitted by the first client device. The second client device may be adapted to transmit information relating to an acceptance or a rejection of the offer, and the server may provide a notification to the first client device of the acceptance or rejection of the offer.

The information stored on the database may include an application for lease and a proposed lease agreement for the rental property, each of which may be transmitted with the notification to the first client device of an acceptance of the offer. The application for the lease and the proposed lease agreement may be viewable by the respective leasor via the first client device. The information stored on the database may also include payment information for the prospective leasee. The server may automatically process a lease application fee when the offer amount equals or exceeds the minimum lease amount. Similarly, the lease application fee may automatically be processed if the offer amount is within the predetermined percentage of the minimum lease amount. The payment information may include a credit card number, banking information suitable for withdrawing the funds from a bank account, a debit card number, and information suitable for withdrawing funds from a payment processing portal.

The server may provide an indication to the leasor after information relating to the attributes of the rental property has been stored on the database and are viewable via the first client device. The information relating to the rental property stored on the database may include a necessary deposit amount and security amounts to be paid by the prospective leasee. The server may automatically process a payment for the deposit amount and/or the security amount upon acceptance of an offer price for a lease amount for the rental property transmitted by the first client device to the second client device via the server.

The information transmitted by the first client device may be a cancellation of an application for lease for the rental property or a cancellation of the lease, if the lease has already been entered into. The server may transmit an indication of the cancellation to the second client device, and the lease application may be withdrawn, or the lease may be cancelled, if the cancellation is transmitted from the first client device within a predetermined amount of time of entry into the lease. Further, the information relating to the attributes for the rental property may include a predetermined time that a minimum lease amount for the rental property may be accepted by the leasor of the rental property. The server may provide a notification to the second client device after expiration of the predetermined time.

A method for using a system of negotiating pricing for a rental property includes receiving information from the first client device and the second client device to be stored on the database and to be transmitted therebetween the global communications network. The method may also include providing an indication to the first client device that an offer for a lease amount has been transmitted by the first client device and transmitting an acceptance or a rejection of the offer. The method may further include providing a notification to the first client device of the acceptance or rejection of the offer.

### BRIEF DESCRIPTION OF THE DRAWINGS

FIG. 1 is a schematic diagram illustrating the system for negotiating a price for rental property according to the present invention.

FIGS. 2-9 are flowcharts illustrating methods of using the system according to the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations refer to similar elements in alternate embodiments.

The system according to the present invention is a computerized system that requires the performance of one or more steps to be performed on or in association with a computerized device, such as, but not limited to, a server, a computer (i.e., desktop computer, laptop computer, netbook or a machine having a processor), a dumb terminal that provides an interface with a computer or server, a personal digital assistant, mobile communications device, such as an iPhone, Blackberry or other similar device which provides computer or quasi-computer functionality, a mobile reader, such as a Kindle, which provides reader functionality that may be enabled through either internal components or connecting to an external computer, server or global communications network (such as the Internet) to take direction from or engage in processes which are then delivered to the mobile reader. It should be readily apparent to those of skill in the art that other types of devices, individually or in conjunction with an overarching architecture associated with an internal or external system, may be utilized to provide the “computerized” environment necessary for the at least one process step to be carried out in a machine/system/digital environment. It should be noted that the method aspects of the present invention are preferably computer implemented methods and, more particularly, at least one step is preferably carried out using a computerized device. In short, a computerized system according to the present invention is meant to include any device having a processor and a memory.

Throughout the specification, the terms renter and leasee may be used interchangeably. Similarly, the terms landlord, rental property owner and leasor may also be used interchangeably. The interchangeable use of these terms is not to be read as a limitation on the invention in any way.

The present invention provides a system and a method for negotiating a rental price for a property between a potential or prospective renter or leasee and a rental property owner, e.g., a landlord or leasor. The system advantageously allows the renter to secure a rental property at a rate below market value while also ensuring that rental property owners receive more than a threshold minimum value. The threshold minimum value may be determined by the rental property owner. The system and method of the present invention also advantageously improves user satisfaction, of both the rental property owner and the renter, by incorporating contingencies on both sides of the agreement. More specifically, the agreement can be contingent upon the renter completing a lease application to the satisfaction of the landlord, thereby ensuring to the landlord that the renter is of a predetermined quality standard (as set by the landlord.) The agreement may also be contingent on the renter's satisfaction with the specific property to be rented. More particularly, the agreement may include an opt-out clause for the renter if the renter is not satisfied with the premises to be leased.

The system and method of the present invention may also advantageously provide the renter with an incentive to make a timely decision on accepting the contract by giving a limited time in which the negotiated contract price is valid, i.e., negotiated price may only be valid for 30 days. The system may be built using a web-based client-server architecture, and allows both the rental property owner and renter to enter conditions such as unit type, community, location, etc. To be more specific, the present invention advantageously provides a renter, or a user, with a way to negotiate a discounted price on a rental property. The present invention is also advantageous for a property manager as it provides a way for the property manager to liquidate excess inventory by discounting the price of a rental property without necessarily compromising an overall pricing strategy. Accordingly, the present invention decreases economic losses to both prospective renters and landlords, by allowing the prospective renter to negotiate a price for an available rental property. The negotiated price is preferably a lower price than would be generally offered and/or negotiated, but it is not necessary for the price to be a lower one. In fact, it is possible that the price could be the same or even higher, which may be the case with respect to particularly desirable properties or for any properties at certain popular times. The present invention also advantageously allows the rental property owner to collect rental fees, which may be discounted from an original price, such as on properties that may otherwise be and/or remain vacant. It should be understood, however, that the rental fees collected need not be discounted to fall within the scope of the present invention.

As will be in greater detail below, the system of the present invention advantageously includes a database for storing information relating to various aspects of the invention. The information stored on the database may, for example, be related to the prospective renter, the prospective landlord, the rental property, or any other factor that may be necessary for a user, i.e., prospective renter and/or prospective landlord, for making a decision. One of ordinary skill in the art would appreciate, after having had the benefit of the teachings contained herein, that the databases can be a plurality of databases, each of which may be linked to one another, and each of which may be accessible by a user using a user interface. The databases may, for example, be stored on a computer readable medium or may be stored on a memory of a central computer (such as a server, for example) and accessed by users via a global communications network, such as, for example, the internet or a network of connected computers, which may be linked using satellites and/or wireless technologies.

As will further be discussed in greater detail below with reference to the Figures, the system may include a first computerized device, a second computerized device, and a server in communication with the first and second computerized devices. The server may be adapted to receive property description information and a minimum rental rate from a first computerized device. The first computerized device may, for example, be operated by a landlord. The server may also be adapted to receive desired property attributes and a desired rental rate from a second computerized device operated by a potential renter. The server may also send a notification to the first and second computerized devices when the desired rental rate exceeds the minimum rental rate. The server may also be adapted to apply a lease application fee to a credit card provided by the renter when the desired rental rate exceeds the minimum rental rate. This can be done at the same instant that the desired rental rate exceeds the minimum rental rate, or can occur after a predetermined amount of time has passed. Those skilled in the art will appreciate, after having had the benefit of reading this disclosure, that any amount of time may be set as the predetermined amount of time, i.e., seconds, minutes, hours, days, weeks, or even months. This predetermined amount of time may, for example, be related to an inspection period, for example, or even an approval period for the landlord to approve the potential renter.

The server of the system according to the present invention may also be adapted to receive additional lease application information from the second computerized device operated by the potential renter. The server may also operate to send an approval notification to the first computerized device when the lease application information meets predetermined lease application criteria. The server may further operate to provide a rate confirmation to the second computerized device when the lease application meets predetermined lease application criteria. The server may still further be adapted to receive a cancellation notification from the second computerized device and send a cancellation notification to the first computerized device in response to receipt of the cancellation notice from the second computerized device. The rate confirmation may also include an expiration date. Additional details of the invention are described in the appended flowcharts, as well as below.

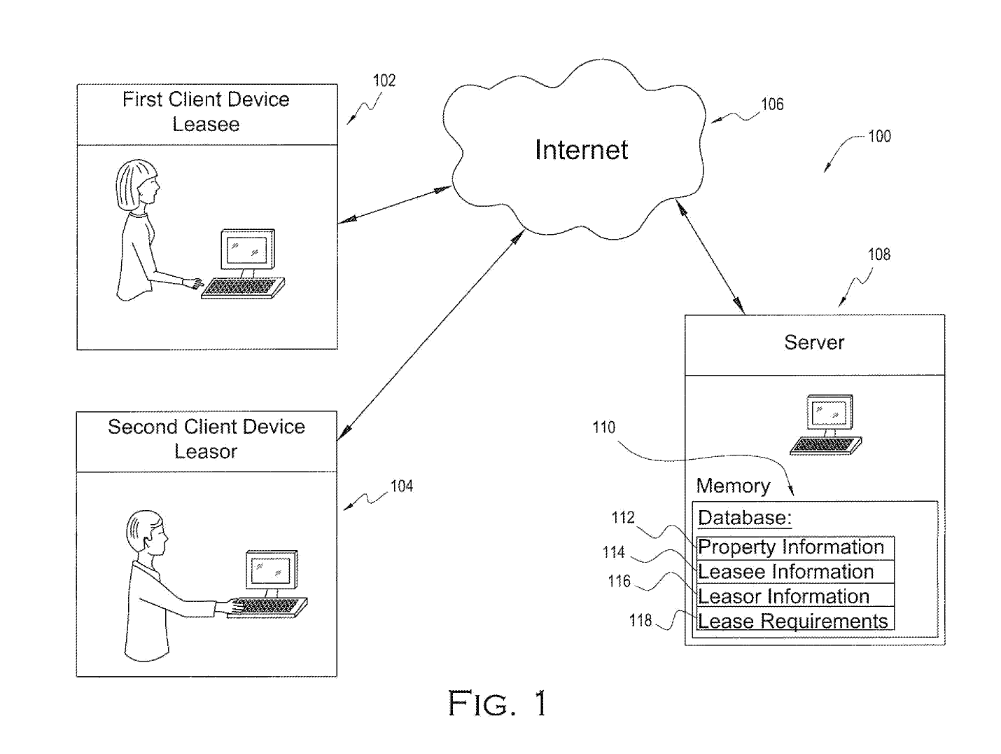

Referring now to FIG. 1, the above referenced features of the system 100 according to the present invention are now described in greater detail. As noted above, the system 100 may include a first client device 102 in communication with a global communications network 106 to be used by a prospective leasee of the rental property. The global communications network 106 may, for example, be the internet, or any other type of global communications network adapted to place multiple client devices in communication with one another and also adapted to allow for the ready transmission of data between client devices. The system 100 may also include a second client device 104 in communication with the global communications network 106 to be used by a leasor of the rental property.

The system 100 may further include a server 108 in communication with the first and second client devices 102, 104 via the global communications network 106. A database 110 is preferably stored on a memory of the server 108. As further illustrated in FIG. 1, the database 110 may include a memory having information stored thereon. The information may relate to attributes of the rental property, attributes of the prospective leasee of the rental property, or attributes of the leasor of the rental property. As also illustrated in FIG. 1, this information may be stored in separate databases. For example, attributes relating to the rental property may be stored on a property information database 112. Further, information relating to attributes of the leasee may be stored on a leasee information database 114, and information relating to attributes of the leasor may be stored on a leasor information database 116. Optionally, requirements relating to attributes of the lease for the rental property may be stored in a separate lease requirements information database 118, or may be incorporated into the property information database 112.

The server 108 may be adapted to receive information from the first and second client devices 102, 104, to be stored on the database 110 and to be transmitted between the first and second client devices via the global communications network 106. Further, the server 108 is adapted to compare the information transmitted by either the first client device 102 or the second client device 104 with information stored on the database 110. After the information is compared, the server 108 may provide an indication to either the first client device 102 or the second client device 104 (or both) indicating compatibility or non-compatibility of the information transmitted by the first and second client devices 102, 104 with the information stored on the database 110.

As an example, and as will be discussed in greater detail below, the second client device 104, which is preferably used by the leasor, may be used to upload attributes relating to the rental property into the database 110 or, alternatively, into the property information database 112. This information may include a minimum rental amount that the leasor may be willing to accept for a rental property. Accordingly, that minimum rental amount may be stored on the property information database 112. The leasee, using the first client device 102, may access information relating to the rental property via the global communications network 106. After accessing information relating to the rental property on the database 110 or the property information database 112 of the server 108 via the global communications network 106, the leasee, using the second client device 104, may transmit information, such as a lease amount offer, to the first client device 102 via the global communications network.

The server may analyze the lease amount offer transmitted by the first client device 102 and compare it to the minimum lease amount stored on the property information database 112 by the leasor using the second client device 104. If the lease amount offer transmitted by the first client device 102 is compatible with the minimum lease amount stored on the property information database 112 by the leasor, then an indication of compatibility of the lease amount offer with the minimum lease amount may be transmitted to both the first client device 102 and the second client device 104. Conversely, if the lease amount offer transmitted by the first client device 102 is not compatible with the information stored on the database 110 or the property information database 112, i.e., the lease amount offer is not equal to, above, or within a predetermined percentage of the minimum lease amount as set by the leasor, then an indication of non-compatibility may be transmitted to both the first and second client devices. Accordingly, and without additional involvement or negotiation between the leasee and the leasor, the rental property listed by the leasor using the second client device 104 may advantageously be leased by the leasee using the first client device 102. Additional details of such a transaction are described below.

As discussed above, the information stored on the database 110, or on the property information database 112, relating to attributes of the rental property may be a minimum lease amount that the leasor of the rental property is willing to accept for the rental property. The information transmitted by the first client device 102 may be an offer of a lease amount for the rental property. Compatibility of the information transmitted by the first client device 102 may be defined by an offer of the lease amount being equal to or exceeding the minimum lease amount for the rental property. Non-compatibility of the information transmitted by the first client device 102 may be defined by the offer of the lease amount being less than the minimum lease amount for the rental property. In some cases, compatibility of the information transmitted by the first client device 102 may be defined by the offer of the lease amount being within a predetermined percentage of the minimum lease amount for the rental property. Non-compatibility of the information may also be defined by the offer of the lease amount not being within the predetermined percentage of the minimum lease amount of the rental property. Accordingly, the system 100 according to the present invention advantageously provides the prospective leasor with various options to set parameters for requirement of leasing the rental property.

Upon transmitting information relating to an offer from the first client device 102 of a lease amount for the rental property, the server 108 may provide an indication to the second client device 104 that an offer of a lease amount has been transmitted by the first client device. In response to the offer transmitted by the first client device 102, the information transmitted by the second client device 102 may be an acceptance or a rejection of the offer. Accordingly, the system 100 according to the present invention advantageously allows the leasor to manually transmit information from the second client device 104 to the first client device 102 in response to receipt of information from the first client device, or the server 108 may automatically transmit a notification relating to information received from the first client device. Therefore, the server 108 may provide a notification to the first client device 102 regarding acceptance or rejection of the offer of the lease amount for the rental property, or the leasor, using the second client device 104, may transmit the notification manually.

The information related to the attributes of the rental property stored on the database 110, or on the property information database 112, may include a proposed lease for the rental property. The proposed lease may be transmitted with a notification to the first client device 102 of the acceptance of the offer for the lease amount. With respect to the lease, the leasor may upload the lease to the database 110 or to the property information database 112 so that the proposed lease for a particular rental property is readily viewable by the prospective leasee using the first client device 102. The leasor may have the option of allowing the proposed lease to be viewable by the prospective leasee using the first client device 102. This advantageously provides the leasee with as much information as possible so that the prospective leasee may readily make a decision regarding the rental property. Further, the leasor may elect to allow for the lease to be revised by a prospective leasee. Upon making a revision to the proposed lease, the prospective leasee may use the first client device 102 to transmit the proposed revisions to the lease to the leasor. The leasor may then have the opportunity to review the proposed revisions to the lease and accept the proposed revisions to the lease, reject the proposed revisions to the lease, or propose alternate revisions to the lease.

The system 100 according to the present invention contemplates that the server 108 may send notifications to the second client device 104 when any number of actions occurs. For example, a notification may be sent to the second client device whenever information that has been posted to the database 110, or the property information database 112, is viewed. Similarly, the system 100 contemplates that a leasee may search the leasor information database 116 to obtain information on a particular leasor. Accordingly, the server 108 may transmit a notification to the second client device whenever information that has been posted on the leasor information database 116 is viewed. Further, if a property is viewed more than one time, or is accessed by a similar user multiple times, the system 100 according to the present invention advantageously contemplates sending a notification to the second client device 104 to alert the leasor of interest by a prospective leasee of a particular rental property. The server 108 may also provide an indication to the leasor using the second client device 104 to confirm that information relating to the rental property has been uploaded and stored on the property information database 112. This advantageously provides confirmation to the leasor that the information relating to the attributes of the rental property are viewable by prospective leasees. There are several other scenarios that will become apparent to the skilled artisan regarding the types of notification that can be sent from the server 108 to the first client device 102 and the second client device 104 based on informant that is stored in the database 110 and information that is accessed and viewed using either the first or second client device.

The information relating to the attributes of the prospective leasee of the rental property may include payment information, and may be stored on the leasee information database 114. The server 108 may automatically process a lease application fee when the offer amount made by the leasee using the first client device 102 is equal to or exceeds the minimum lease amount stored on the property information database 112 by the leasor using the second client device 104. Similarly, the server 108 may automatically process a lease application fee when the offer amount is within a predetermined percentage of the minimum lease amount set by the leasor using the second client device 104 and stored on the property information database 112. The payment information stored on the leasee information database 114 may include a credit card number, banking information suitable for withdrawing funds from a bank account, a debit card number, or information suitable for withdrawing funds from a payment processing portal such as, for example, Paypal®. Those skilled in the art will appreciate that any other form of payment stored on the leasee information database 114 is also acceptable to allow the server to automatically process payments for various fees associated with leasing the rental property to the prospective leasee.

Other fees that are contemplated by the present invention for which the server 108 may automatically process a payment using the payment information stored on the leasee information database 114 include deposit amounts and security amounts to be paid by the prospective leasee upon agreement of a lease amount for the rental property. Deposit amounts and security amounts may be included as information stored on the property information database 112. Accordingly, prior to making an offer for a lease amount for a rental property, the prospective leasee may view such information on the property information database 112 using the first client device 102.

The system 100 according to the present invention advantageously allows the leasor enhanced flexibility and options to require various deposits, e.g., security deposits, pet deposits, first month's rent, last month's rent, etc., as well as the amounts required for the deposits, and the time that the deposits must be paid. The system 100 according to the present invention further advantageously provides the leasee very much flexibility in determining whether deposits are refundable, and the requirements that must be met for a deposit, or any portion thereof, to be refundable.

The system 100 according to the present invention advantageously provides a prospective leasee using the first client device 102, the ability to view as much information as possible regarding the rental property prior to making an offer. This is advantageous as a deposit amount, or a security amount that may be required by the leasor as stored in the property information database 112, may not be suitable to a prospective leasee, even though the proposed lease amount may be suitable to the leasee. By providing the enhanced amount of information on the property information database 112, the system 100 according to the present invention advantageously limits the communication necessary between the prospective leasee and the leasor using the prospective first client device 102 and the second client device 104 so that the prospective leasee and the leasor may readily enter into a lease for a rental property.

The system 100 according to the present invention advantageously contemplates the scenario where a prospective leasee may have entered into a lease with the leasor for a rental property, but has quickly decided that it was a mistake or, for some other reason, wishes to cancel the lease. In such a scenario, the information transmitted by the first client device may be a cancellation of the lease. Upon receipt of the cancellation of the lease, the server 108 may transmit an indication to the second client device 104 regarding receipt of the cancellation notification. Cancellation requirements may be uploaded to the database 110, or to the property information database 112, by the leasor using the second client device 104. Upon receipt of the cancellation request from the first client device 102, the server 108 may compare the cancellation request to the information stored on the database 110, or the property information database 112, to determine if the cancellation request is compatible with the cancellation requirements stored on the database. If it is determined that the cancellation request is compatible with the information stored on the database 110, or the property information database 112, then the lease is cancelled. If, however, it is not compatible, then the lease is not cancelled. The present invention contemplates that the leasee need not necessarily enter into a lease, but may simply fill out a lease application upon acceptance of an offer. As such, it is contemplated that the system 100 according to the present invention provides the ability to the leasee to withdraw the lease application. This action may be considered a type of cancellation.

The leasor may use the second client device 104 to upload various scenarios for cancellation of the lease onto the database 110 or the property information database 112. Some of these scenarios may include setting a predetermined amount of time within which a cancellation of a lease will be allowed, setting an amount of a refund that may be paid to the prospective leasee upon cancellation of the lease, setting a sliding scale for a percentage of the refund that may be paid back to the prospective leasee that is relative to the time within which the cancellation was submitted, or any number of other scenarios, as understood by those skilled in the art, after having had the benefit or reading this disclosure. This is also applicable to a situation wherein the prospective leasee has merely completed and submitted an application for lease. In other words, it is contemplated that an application for a lease may be accompanied by a predetermined fee. Should the prospective leasee wish to withdraw the application for the lease within the predetermined amount of time, the same types of refund provisions indicated above may also be put into place.

The system 100 according to the present invention advantageously provides the leasor with the option to list a particular rental property for a predetermined amount of time. For example, a leasor may desire to list a rental property for one week, or until the rental property is leased. The system 100 according to the present invention allows the leasor, using the second client device 104 to readily list the rental property for any amount of time that is desired. After setting the amount of time that the rental property may be listed for, the server 108 may provide a confirmation indication to the leasor at the second client device 104 that the predetermined time has been set. As the end of the predetermined time approaches, the server 108 may provide warning indications to the leasor at the second client device 104 that the predetermined time is approaching its end. The indication may provide the leasor with the ability to extend the predetermined time, keep the predetermined time as it currently stands, or even decrease the amount of predetermined time.

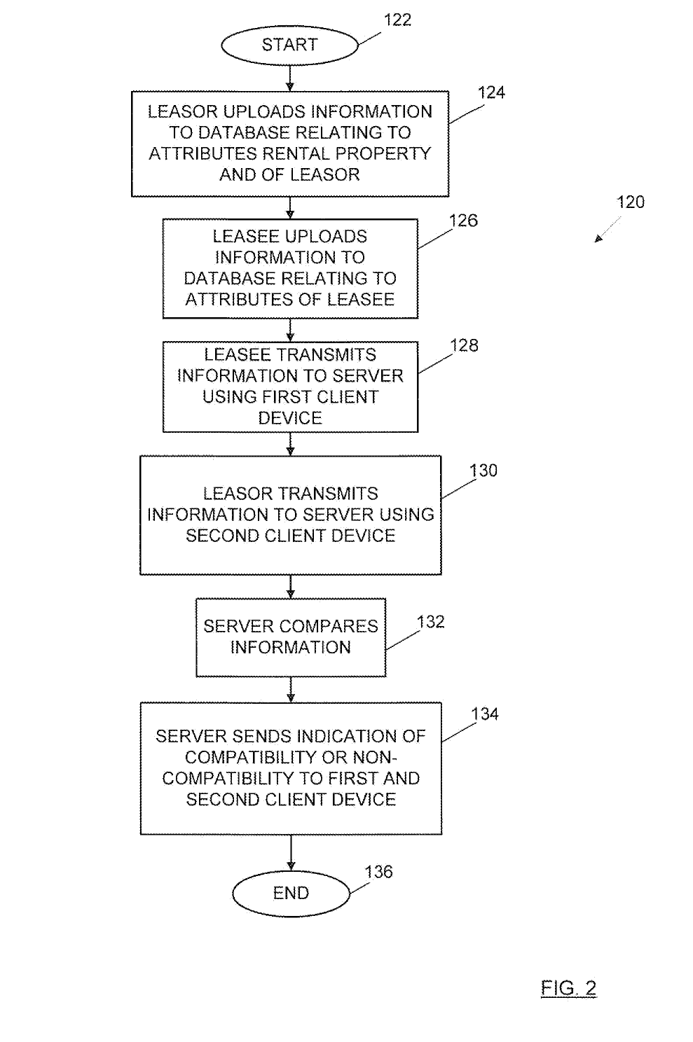

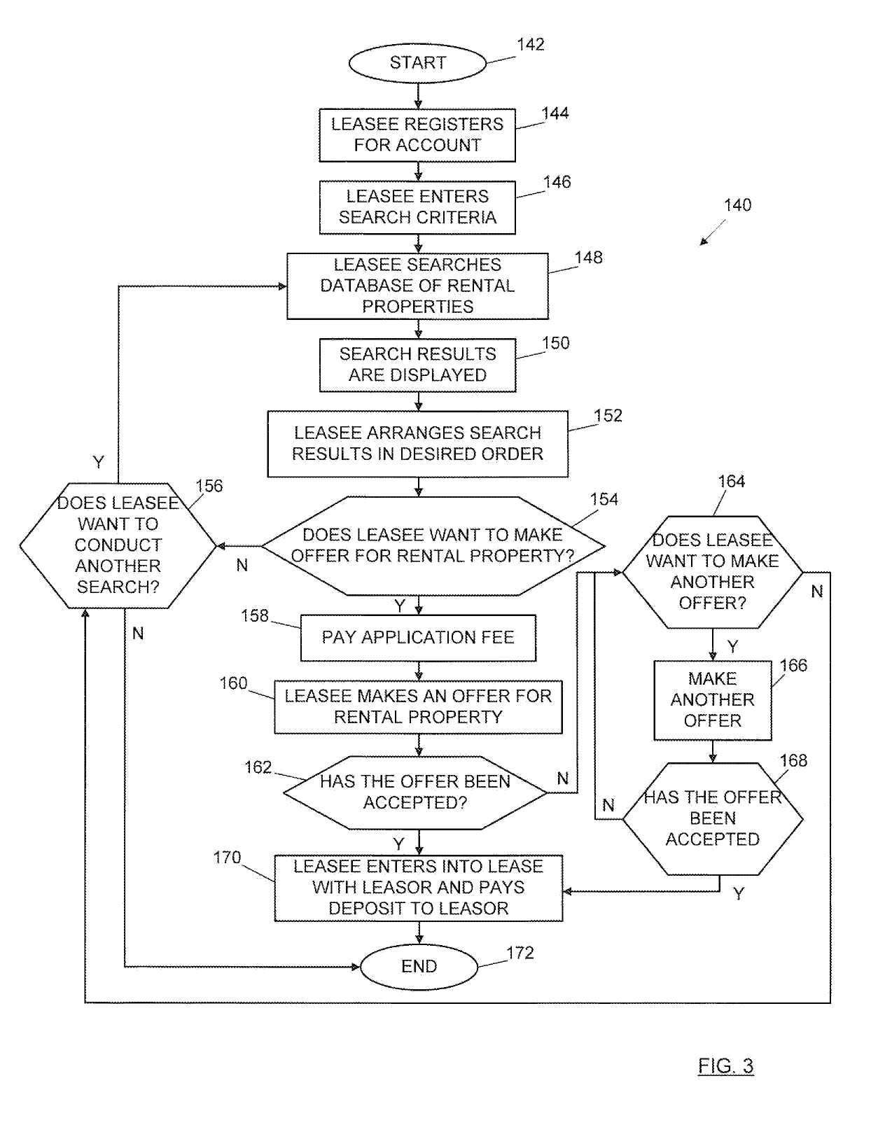

Referring now additionally to the flowchart 120 illustrated in FIG. 2, a method aspect of the present invention is now described in greater detail. From the start (Block 122), the leasor may upload information to a database relating to attributes of the rental property and of the leasor at Block 124. More specifically, the attributes relating to the rental property may be uploaded to the property information database 112, and the information relating to attributes of the leasor may be uploaded to the leasor information database 116. Depending on the type of information that is uploaded by the leasor, the information may also, optionally be stored in the lease requirements information database 118. At Block 126, the leasee may upload information to the database relating to attributes of the leasee. The information relating to attributes of the leasee may be uploaded to the leasee information database 114. At Block 128, the leasee may transmit information to the server using the first client device. At Block 130, the leasor may transmit information to the server using the second client device. The server compares the information at Block 132, and sends an indication of compatibility or non-compatibility to the first and second client devices at Block 134. Alternately, and as described above, the prospective leasee may transmit information directly to the leasor via the global communications network, and vice-versa. The method is ended at Block 136.

Referring now additionally to FIG. 3, additional aspects of the invention are now described in greater detail. A flowchart 140 illustrated in FIG. 3 describes a prospective leasee's use of the system. From the start (Block 142), a leasee may register for an account at Block 144. The leasee may register for the account at Block 144 by entering personal information, such as name, current address, length of rental time, and many other factors. This information is thereafter stored in the leasee information database 114. At this stage, the present invention contemplates that the leasee may provide authorization for a credit check and/or background check to be conducted. Of course, such a check can be accomplished at some later point in time, such as immediately before an agreement is entered into, which in fact may be more advantageous from the point of view of the prospective leasee. Similarly, this check can take place in serial fashion, either on demand or at pre-determined intervals, so as to continue to verify the credit and background status of the prospective renter. After learning the teachings contained herein, one skilled in the art would appreciate that the step of the user, i.e., prospective leasee, providing authorization to run a credit check can occur at any stage using the present invention.

At Block 146, the leasee may enter search criteria for a desired rental property. The search criteria may include a location of the rental property, number of bedrooms, number of bathrooms, whether or not smoking is permitted on the rental property, whether or not pets are permitted on the rental property, or selecting various other amenities. At Block 148, the leasee may search the database of rental properties. The present invention contemplates, that a user may conduct a search either prior to registering as a user or after registering as a user. In other words registering as a user may not be necessary in order for a user to conduct a search. Accordingly, the system and method according to the present invention advantageously simplifies searching for rental properties by providing the user the option to register as a user before or after the search is completed. The present invention also contemplates that various levels of information may be provided to users based on whether or not they are registered users. For example, the search results may provide minimal information regarding the rental property to users that are not registered users, and more detailed information directed to the rental property for those users who are registered. This is an optional feature and not meant to be limiting.

At Block 150, the search results may be displayed to the leasee. These search results are preferably displayed based on the criteria entered by the leasee at Block 146. At Block 152, the leasee may arrange the search results in a desired order. The desired order may be based on any number of factors. For example, the desired order may be based upon proximity to a desired location, length of time that the property has been vacant, price of requested rent, or any other number of factors.

At Block 154, it is determined whether or not the prospective leasee desires to make an offer for the rental property. If it is determined at Block 154 that the prospective leasee does not want to make an offer for the rental property, then it is determined at Block 156 whether or not the user desires to conduct an additional search of the database. If it is determined at Block 156 that the user desires to conduct another search of the database, then the user may conduct the search of the database at Block 148. If, however, it is determined at Block 156 that the user does not desire to conduct another search of the database, then the method is ended at Block 172.

If the prospective leasee desires to make an offer for the located rental property at Block 154, then the prospective leasee may be prompted to pay an application fee at Block 158. After having had the opportunity to review this disclosure, one skilled in the art would appreciate that the application fee is generally associated with filling out a typical rental application. Of course, the present invention contemplates that an application fee may not be required by a landlord. Further, there may be instances where the landlord does not even require a rental application. The present invention also contemplates that an application fee may be required, but that the landlord may chose to waive the application fee as a promotion, for example. The present invention still further contemplates that the requirement of an application fee and the requirement of a rental application may be some of the criteria that may be used to search for available rental properties. In other words, the present invention advantageously allows a user to search for rental properties based on whether or not an application fee is required, whether or not a rental application is required or any combination thereof.

At Block 160, the prospective leasee may make an offer for the rental property. The offer may be a proposed monthly price that the prospective is willing to pay for the rental property or may be a lump sum price based on a full term of the lease. Those skilled in the art will appreciate, after having learned from the teachings of this disclosure, that the offer price may also be a percentage of an asking price being displayed by the prospective landlord, or any other type of offer for the rental property, i.e., less expensive initial rent with escalation built in over a predetermined number of months, first month free, waiver of deposit, etc. Those skilled in the art will also appreciate, having had the benefit of the teachings of this disclosure, that the application fee may be paid at any time, i.e., after the user makes the offer for the rental property.

At Block 162, it is determined whether or not the offer price has been accepted by the leasor. If it is determined at Block 162 that the offer price has not been accepted, then it is determined at Block 164 whether or not the prospective leasee desires to make another offer. If it is determined at Block 164 that the prospective leasee does not desire to make another offer, then it is again determined at Block 156 whether or not the prospective leasee wants to conduct another search. If it is determined at Block 156 that the prospective leasee does not want to perform another search, then the method is ended at Block 172. If, however, it is determined at Block 156 that the prospective leasee does desire to conduct another search, then the prospective leasee is directed to conduct another search at Block 148.

If it is determined at Block 164 that the prospective leasee desires to make another offer, then the prospective leasee may make another offer for the rental property at Block 166. At Block 168, it is determined whether or not the offer has been accepted by the leasor. If it is determined at Block 168 that the offer has not been accepted by the leasor, then it is again determined at Block 164 whether or not the prospective leasee desires to make another offer. If it is determined at either Block 162 or Block 168 that the offer has been accepted, then the prospective leasee may enter into a lease with the landlord at Block 170. Further, the prospective leasee may also pay a deposit to the landlord at Block 170 if so required. As indicated above, it is contemplated that the prospective leasee need not enter into a lease with the landlord at Block 170, but that the prospective leasee may fill out and transmit an application for a lease upon acceptance of the offer at Block 162 or Block 168. This advantageously enhances the ability of the landlord to control rental of the property as desired. For example, there may be an instance where a prospective leasee has made an offer that is otherwise acceptable for the rental property, but upon receipt of an application for a lease, the landlord has decided that it is not desirable to lease the rental property to the prospective leasee. For example, it may be determined that the prospective leasee has a credit score that is below a predetermined threshold amount, or that the application for lease provides an indication that the prospective leasee has a poor rental history. In such a case, the present invention contemplates that the landlord may be free to decline leasing the rental property to the prospective leasee and need not move to the step of entering into the lease. Factors that may prohibit entry of a lease can be predefined by the landlord when listing the property for lease.

The present invention contemplates that the leasor may not require a deposit. Further, if the leasor does require a deposit, the present invention contemplates that the deposit may be waived by the leasor. The present invention also contemplates that the prospective leasee may also make an offer for the deposit, i.e., the deposit amount, if any, which may be negotiated into the offer made by the prospective leasee. The present invention still further contemplates that the deposit may be a factor used when entering search criteria to search for available rental properties. After the transaction between the leasor and the prospective leasee is completed at Block 170, the method is ended at Block 172.

The method illustrated in the flowchart 140 illustrated in FIG. 3 describes several steps that may be performed in any order and that may be optional. For example, the present invention contemplates that the prospective leasee may register as a user at any stage of use of the system. Another example, is that the lease may or may not be a transaction that is carried out using the system, i.e., the lease transaction portion may be a step that is carried out directly between the landlord and the renter. After having had the benefit of this disclosure, the skilled artisan will appreciate that the transaction between the landlord and the prospective renter may take place in any number of ways, provided however, that the prospective renter is afforded an opportunity to make an offer for a rental property that may be below a market value, for example, and that the landlord is afforded an opportunity to lease vacant space by making the space available for a rental price that may be lower than an asking price. The present invention may also be advantageous in very good markets, i.e., when the supply of rental properties is low and the demand for rental properties are high. The present invention contemplates an auction style for obtaining the highest price for a rental property. This can be especially applicable in the case of vacation rental properties, for example.

The present invention contemplates the possibility of providing the user with a suggested price that may be accepted by the landlord. This suggested price may be calculated using any number of formulas. For example, a landlord when listing their property for rent may specify a suggested price. This suggested price may, for example, exceed the minimum price that the landlord is willing to accept, or may be equivalent to the minimum price that the landlord is willing to accept for the rental property. The present invention also contemplates the possibility of requiring the renter to wait for a predetermined amount of time before making a second offer.

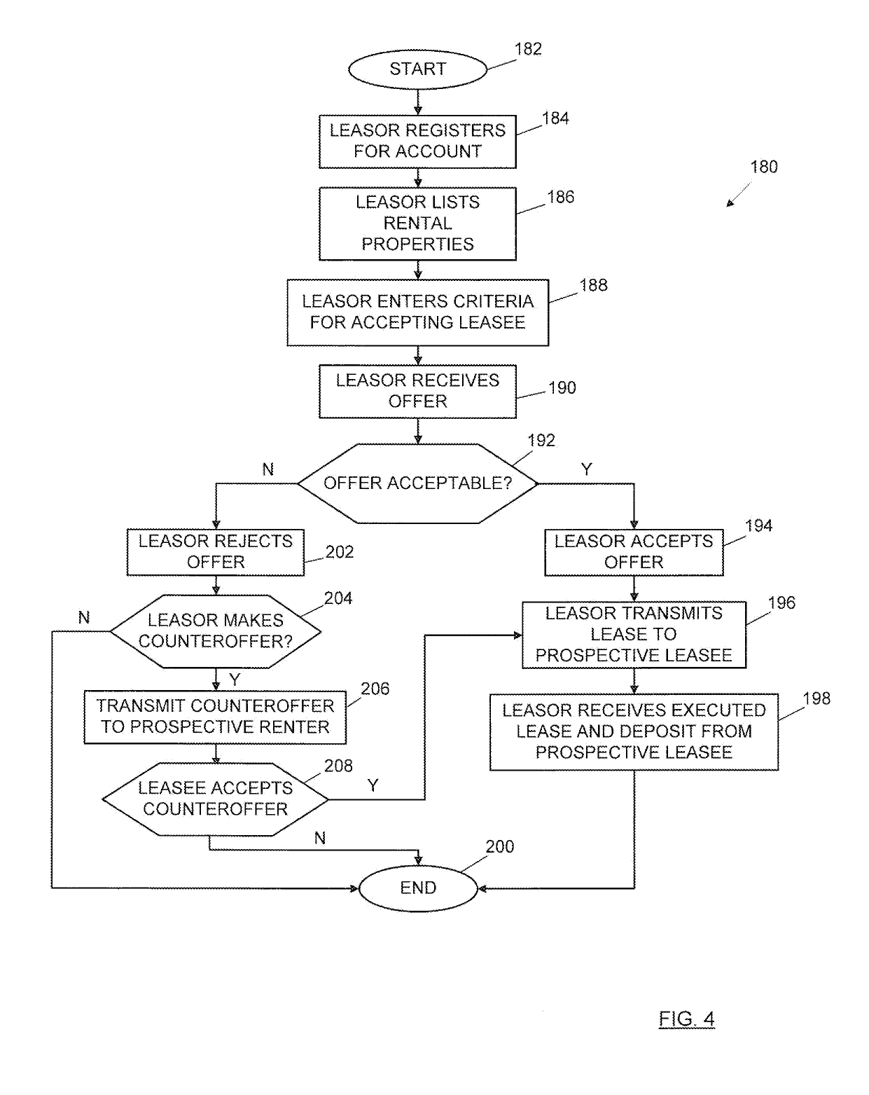

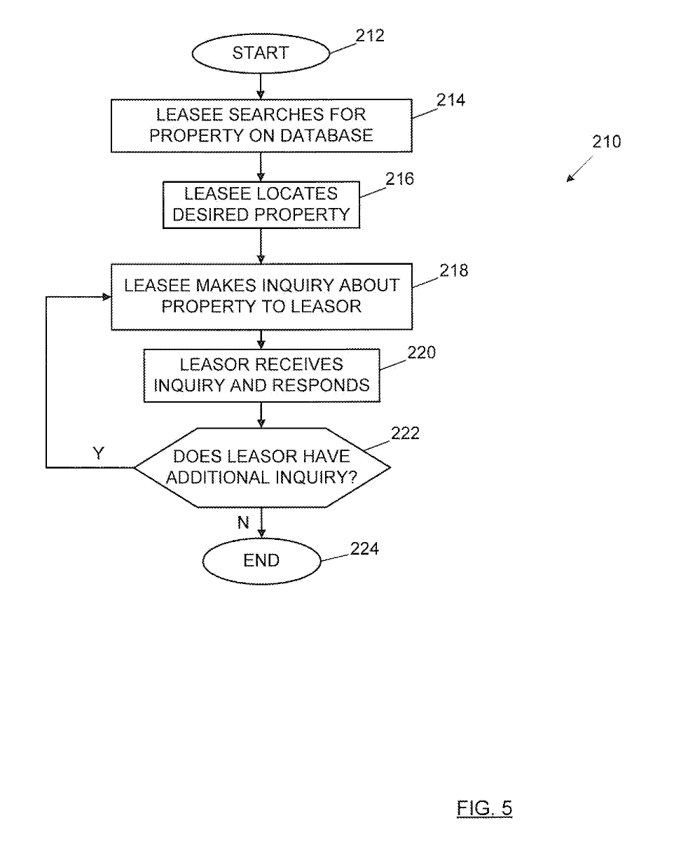

Referring now additionally to the flowchart 180 of FIG. 4, another method aspect according to the present invention is now described in greater detail. More specifically, the flowchart 180 illustrated in FIG. 4 is directed to a method for the landlord, or leasor, to use the system according to the present invention. Again, throughout this disclosure the terms landlord and leasor are interchangeably used. From the start Block 182, the leasor may register for an account on the system at Block 184. Registration of the leasor at Block 184 may include entering information directed to the leasor, i.e., name, rental history, properties owned, or any other type of pertinent information. The present invention contemplates that when the leasor registers for an account at. Block 184, the leasor may also pay a registration fee. This registration fee is, however, optional.

At Block 186, the leasor may list available rental properties. The information associated with listing the rental properties includes any information relating to the particular rental property. This information may be stored in the database 110 or, optionally, in the property information database 112. For example, the leasor will likely enter specifications directed to the rental property, such as the number of bedrooms, the number of bathrooms, whether or not smoking is permitted, whether or not pets are permitted, etc. This system according to the present invention also contemplates that the leasor may pay a registration fee, or a listing fee, associated with each rental property that is listed.

At Block 188, the leasor enters various criteria for accepting an offer from a renter. Again, this information may be entered into and stored in the database 110 or the property information database 112. More specifically, the criteria may include whether or not the leasor is willing to allow smoking on the rental premises, pets, the lowest price that the leasor will accept for the rental property, or any combination of such factors. Those skilled in the art will appreciate, after having had the benefit of reading this disclosure, that several other factors may be taken into account before determining whether or not to accept an offer for a rental property. Further, the present invention contemplates that any combination of factors may be used to determine whether or not an offer may be accepted, and these factors may be taken into account on a sliding scale. Weight may be given to various factors based on importance by the leasor. For example, more weight can be given to the rental price, and less weight may be given to whether or not the renter desires to have pets on the premises.

At Block 190, the leasor receives an offer from a prospective renter for a predetermined rental property. At Block 192, it is determined whether or not the offer received by the leasor is acceptable. If it is determined at Block 192 that the offer received by the leasor is acceptable, then the leasor may accept the offer at Block 194. At Block 196, the leasor may transmit a lease to the prospective renter (leasee) and at Block 198, the leasor may receive an executed lease and a deposit from the prospective renter. As mentioned above, however, it is optional whether or not the leasor will receive a deposit from the prospective renter. More specifically, this may be one factor that the leasor may use in gauging whether or not to accept an offer from a renter. The system according to the present invention contemplates that the lease may be a form lease that is stored on the database of the system that the prospective renter may access and agree to, i.e., a click type of agreement, or may be a lease that may be transmitted to the prospective renter from the leasor to be executed. After the transaction between the renter and the leasor is completed at Block 198, the method may be ended at Block 200.

If it is determined at Block 192 that the offer received from the prospective renter is not acceptable, then the leasor may reject the offer at Block 202. At Block 204 it is determined whether or not the leasor desires to make a counteroffer to the prospective renter. If it is determined at Block 204 that the leasor does not desire to make a counteroffer, then the method is ended at Block 200. If, however, it is determined at Block 204 that the leasor desires to make a counteroffer to the prospective renter, then a counteroffer may be transmitted to the prospective renter at Block 206.

At Block 208 it is determined whether or not the renter has accepted the counteroffer. If, at Block 208, it is determined that the renter has accepted the counteroffer, then the process resumes at Block 196 wherein the leasor transmits a lease to the prospective renter, and wherein the leasor receives an executed lease, and possibly, a deposit from the prospective renter at Block 208. If, however, it is determined at Block 68 that the renter has not accepted the counteroffer, then the method is ended at Block 200.

The present invention contemplates that the leasor can see reporting on the performance of their properties within a management console similar to that which lists all of their properties that they enter in the community information. The present invention further contemplates that a leasor may be able to create multiple subaccounts to portion off management of data relating to their rental properties.

Still another method aspect of the present invention is described in the flowchart 210 illustrated in FIG. 5. More specifically, the flowchart 210 illustrated in FIG. 5 is directed to inquiries regarding the rental property made by the renter to the leasor. From the start (Block 212), the renter may search for rental properties on a database at Block 214. At Block 216, the renter may locate a desired rental property. At Block 218, the renter may make an inquiry about the rental property to the leasor. This inquiry may, for example, include information relating to amenities, fixtures on or within the rental property, or any information that the leasor did not include in the initial listing of the rental property. At Block 220, the leasor may receive the inquiry and respond to the prospective renter. At Block 222, it is determined whether or not the prospective renter has any additional inquiries. If it is determined at Block 222 that the prospective renter has any additional inquiries, then the renter may make an additional inquiry regarding the rental property at Block 218. If, however, it is determined at Block 222 that the renter does not have any additional inquiries, then the method is ended at Block 224.

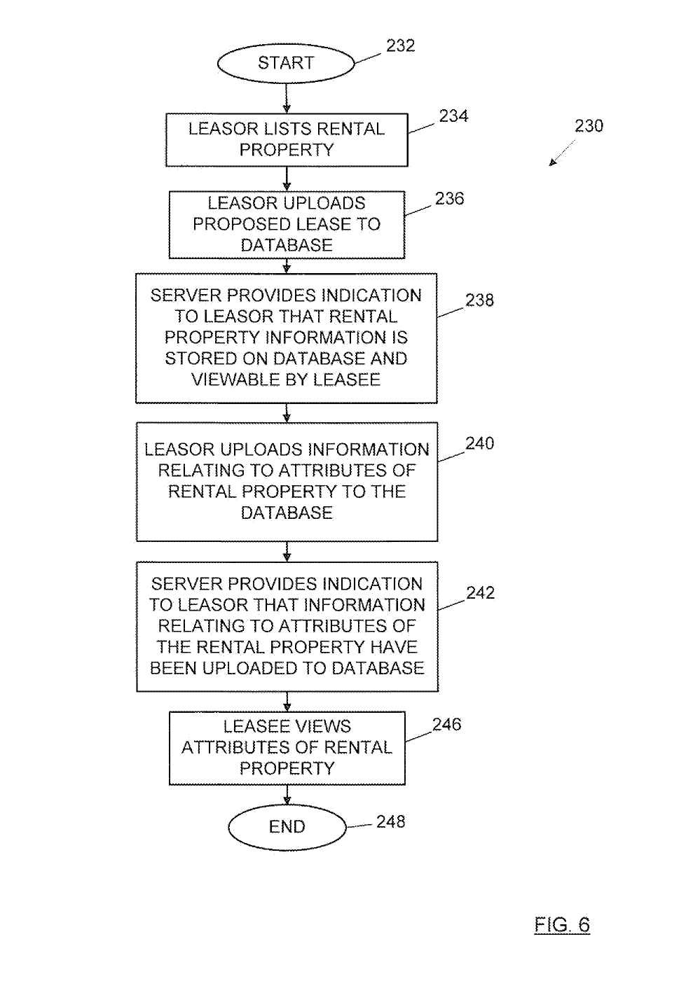

Referring now to the flow chart 230 illustrated in FIG. 6, another method aspect of the present invention is now described in greater detail. From the start (Block 232), the leasor may list the rental property at Block 234. At Block 236, the leasor may upload a proposed lease to the database. As described above, the proposed lease may be uploaded to the main database 110, or into a sub-database containing attributes of the rental property 112. Those skilled in the art, after having had the benefit of reading this disclosure, will appreciate that the sub-database may be a stand-alone database.

At Block 238, the server provides an indication to the leasor that the rental property information is stored on the database and viewable by the leasee. At Block 240, the leasor may upload information relating to attributes of the rental property to the database. At Block 242, the server may provide an indication to the leasor that information relating to the attributes of the rental property has been uploaded to the database. These attributes may be different than the attributes relating to the lease. More specifically, the attributes of the rental property may include, for example, the specifications of the rental property, the minimum lease amount that the leasor is willing to accept for the rental property, whether or not pets are allowed on the rental property, or any other information relating to the rental property as understood by those skilled in the art. At Block 246, the leasee may view attributes of the rental property. The method is ended at Block 248.

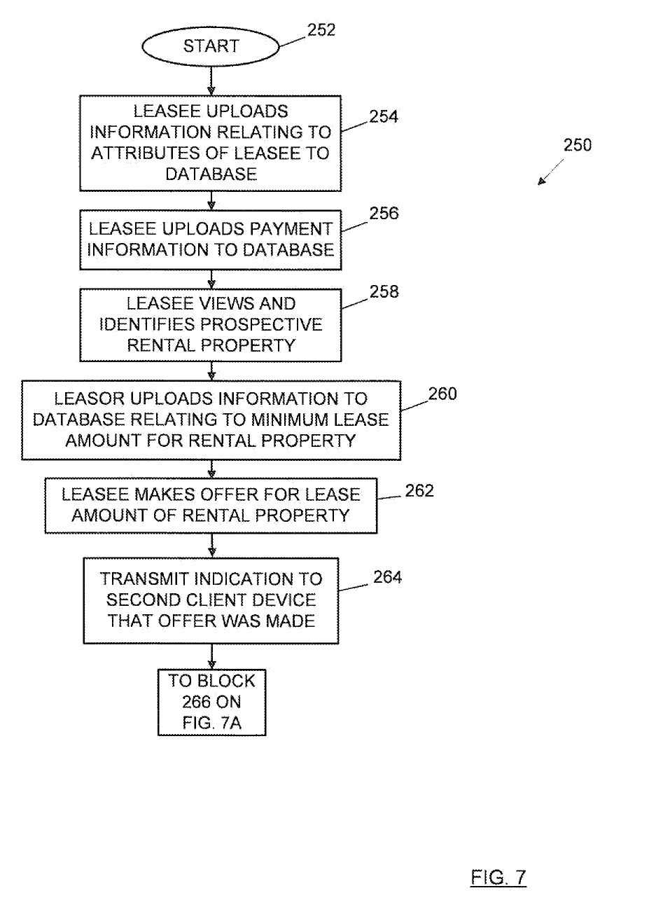

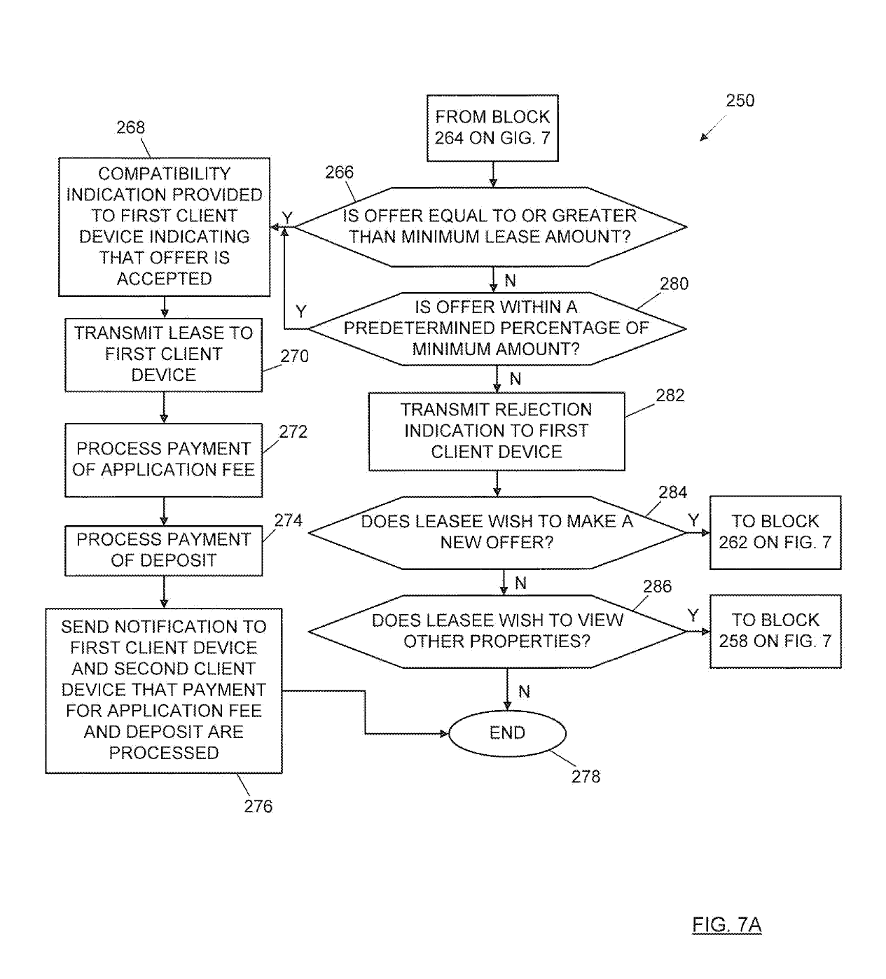

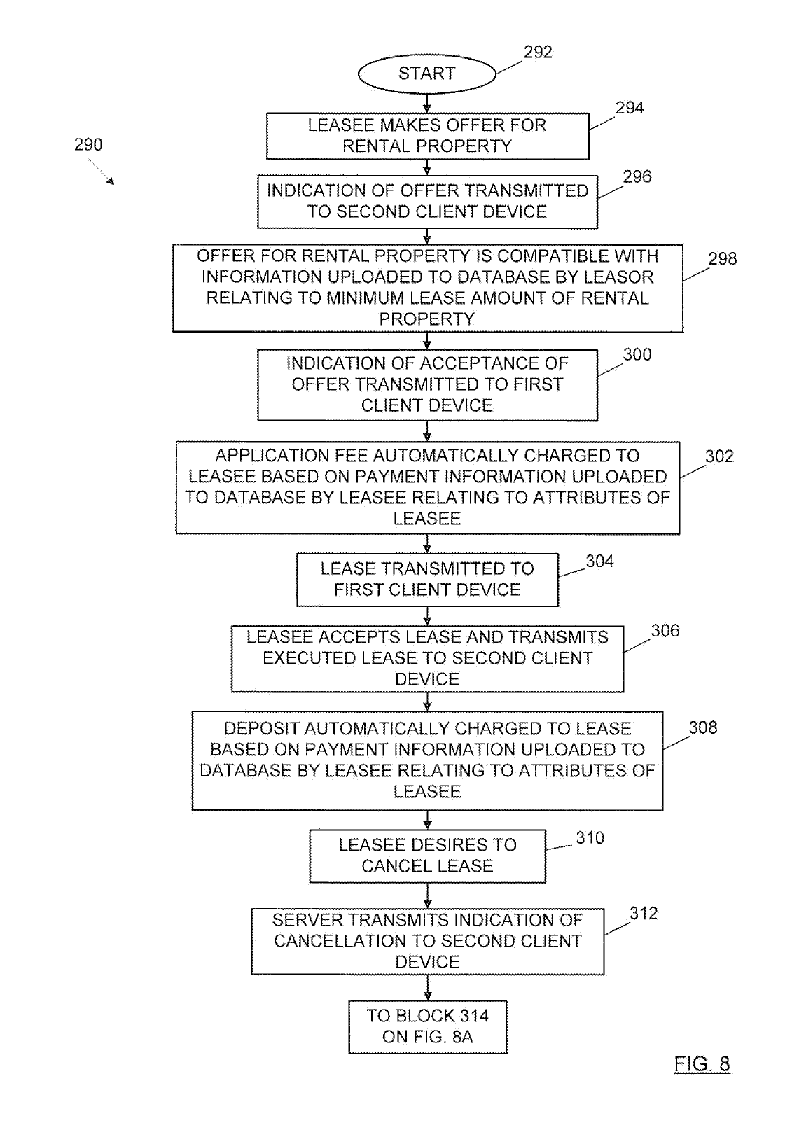

Referring now additionally to the flow chart 250 illustrated in FIGS. 7 and 7A, an additional method aspect according to the present invention, is now described in greater detail. From the start (Block 252), the leasee may upload information relating to attributes of the leasee to the database 110 at Block 254. Alternately, the leasee may upload the information relating to attributes of the leasee to the leasee information database 114. At Block 256, the leasee may upload payment information to the database. Again, this information may be uploaded to either the database 110 or the leasee information database 114. At Block 258, the leasee may view and identify prospective rental properties. At Block 260, the leasor may upload information to the database relating to a minimum lease amount that the leasor is willing to accept for the rental property. At Block 262, the leasee may make an offer for the lease amount of the rental property. At Block 264, an indication is transmitted from the server to the second client device that an offer for a lease amount was made by a prospective leasee from the first client device. The method continues at Block 266 on FIG. 7A.

At Block 266, it is determined whether or not the offer amount is equal to or greater than the minimum lease amount specified by the leasor at Block 260. If it is determined at Block 266 that the offer is equal to or greater than the minimum lease amount, then at Block 268, a compatibility indication is provided to the first client device which, in turn, acts as an indication that the offer has been accepted. At Block 270, a proposed lease may be transmitted to the first client device. An application fee payment may be processed at Block 272 using the payment information uploaded by the leasee at Block 256. At Block 274, the server may process payment of a deposit, also using the payment information uploaded by the leasee at Block 256. At Block 276, a notification may be sent to the first client device and the second client device that payments for the application fee and the deposit (if applicable) have been processed. Thereafter, the method may be ended at Block 278.

If, however, it is determined at Block 266 that the offer for the lease amount is not equal to or greater than the minimum lease amount specified by the leasor, then at Block 280, it may be determined whether or not the offer for the lease amount is within a predetermined percentage of the minimum lease amount specified by the leasor. The determination at Block 280 is only made if an option for accepting an offer for a lease amount within a predetermined percentage of the minimum lease amount is selected by the leasor, If it is determined at Block 280 that the offer for the lease amount transmitted by the first client device is within the predetermined percentage of the minimum lease amount that the leasor is willing to accept, then the method continues at Blocks 268, 270, 272, 274, 276, and is ended at Block 278, as described above. If, however, it is determined at Block 280 that the offer is not within the predetermined percentage of the minimum lease amount that is specified by the leasor at Block 260, then a rejection indication is transmitted from the server to the first client device at Block 282. Alternately, if the leasor does not select an option to accept a lease amount offer that is within a predetermined percentage of the minimum lease amount, then the rejection may be transmitted at Block 282 directly upon determining that the offer for the lease amount is not equal to or greater than the minimum lease amount that the leasor is willing to accept for the rental property at Block 266.

Thereafter, it is determined at Block 284 whether or not the leasee wishes to make a new offer for a lease amount of the rental property. If it is determined at Block 284 that the leasee wishes to make a new offer for a lease amount, then the leasee may make the offer for the lease amount of the rental property at Block 262 on FIG. 7, and the method may continue as described above. If, however, it is determined that the leasee does not wish to make a new offer for a lease amount at Block 284, then it is determined at Block 286 whether or not the leasee wishes to view other properties. If it is determined at Block 286 that the leasee wishes to view other rental properties, then the leasee may view and identify prospective rental properties at Block 258 on FIG. 7, and the method may continue as described above. If, however, it is determined at Block 286 that the leasee does not wish to view other properties, then the method is ended at Block 278.

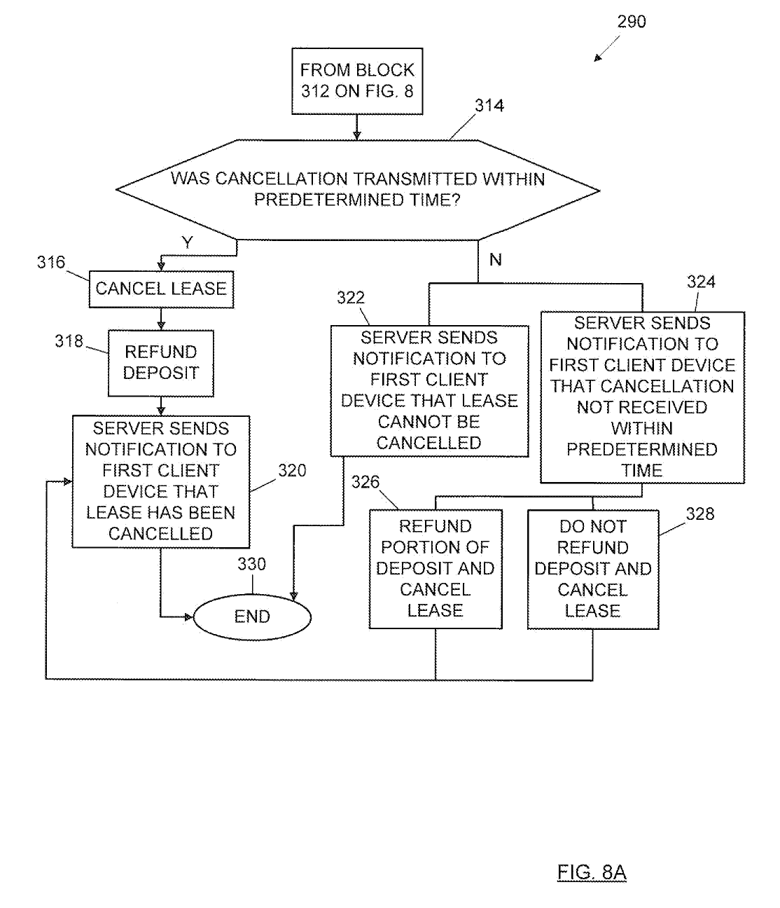

Referring additionally to the flow chart 290 illustrated in FIGS. 8 and 8A, an additional method aspect according to the present invention is now described in greater detail. From the start (Block 292), the leasee may make an offer for the rental property at Block 294. At Block 296, an indication of the offer for the rental property may be transmitted to the second client device. At Block 298, it is determined that the offer for the rental property is compatible with the information uploaded to the database by the leasor relating to the attributes of the rental property. At Block 300, an indication of acceptance of the offer is transmitted to the first client device.

At Block 302, an application fee may automatically be charged to the leasee based on payment information uploaded to the database by the leasee. At Block 304, a proposed lease is transmitted to the first client device so that the leasee may review the terms of the lease. At Block 306, the leasee may accept the proposed lease and transmit an executed lease to the second client device. Those skilled in the art will appreciate that an executed lease may include an electronically signed lease, or any other method known to indicate electronic acceptance of terms and conditions of an executed lease. At Block 308, a deposit may be automatically charged to the leasee based on the payment information uploaded to the database by the leasee.

At Block 310, it may be determined that the leasee desires to cancel the lease or withdraw an application for a lease. At Block 312, the server may transmit an indication of cancellation to the second client device. The method is thereafter continued at Block 314 of FIG. 8A, where it may be determined whether or not the cancellation indication was transmitted within the predetermined time as previously determined by the leasor using the second client device to upload information to the database relating to attributes of the rental property. If it is determined at Block 314 that the cancellation notification was transmitted within the predetermined time, then the lease is cancelled at Block 316, and the deposit (if applicable) is refunded to the prospective leasee at Block 318. It is contemplated by the present invention that an application fee (if applicable) may also optionally be refunded. At Block 320, the server sends a notification to the first client device that the lease has been cancelled, and the method is ended at Block 330.

If, however, it is determined at Block 314, that the cancellation indication was not transmitted within the predetermined time, the server may send a notification to the first client device that the lease cannot be cancelled at Block 322. Thereafter, the method may be ended at Block 330. Alternately, at Block 324, the server may send a notification to the first client device that the cancellation was not received within the predetermined time. Thereafter, a portion of the deposit may be refunded and the lease may be cancelled at Block 326. Another option is illustrated at Block 328 wherein the lease may be cancelled and no refund of the deposit may be made. In either case illustrated at Blocks 326 and 328, a notification may thereafter be sent to the first client device that the lease has been cancelled at Block 320. Thereafter, the method is ended at Block 330. Again, the process illustrated in FIG. 8 is also applicable in cases where the prospective leasee has not necessarily entered into a lease, but has merely completed an application for a lease. In such a case, instead of cancelling the lease, the process is directed to withdrawing the lease application.

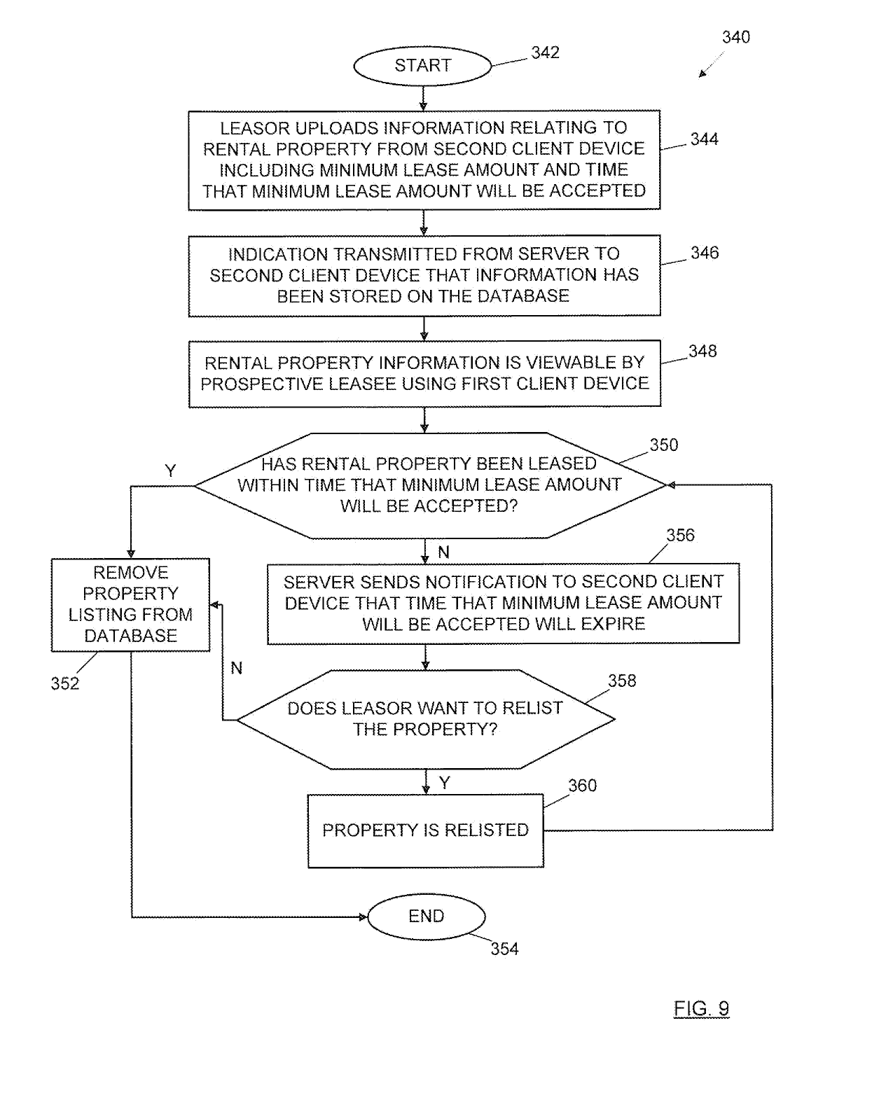

Referring now additionally to the flow chart 340 illustrated in FIG. 9, yet another method aspect of the present invention is described in detail. From the start (Block 342), the leasor may upload information relating to the rental property from the second client device including a minimum lease amount and the time that the minimum lease amount will be accepted at Block 344. At Block 346, an indication is transmitted from the server to the second client device that information has been stored on the database. At Block 348, the rental property information is viewable by the prospective leasee using the first client device.

At Block 350, it is determined whether or not the rental property has been leased within the time that the minimum lease amount will be accepted as specified in Block 344. If it is determined at Block 350 that the rental property has been leased within the time that the minimum lease amount will be accepted, then the property listing is removed from the database at Block 352 and the method is ended at Block 354. If, however, it is determined at Block 350 that the rental property has not been leased within the time that the minimum lease amount will be accepted, the server sends a notification to the second client device that the time that the minimum lease amount will be accepted will expire at Block 356. At Block 358, it is determined whether or not the leasor wants to relist the property. If it is determined at Block 358 that the leasor desires to relist the property, then the property is relisted at Block 360, and it is again determined at Block 350 whether or not the property has been leased within the time that has been determined that the minimum lease amount will be accepted at Block 350. If, however, it is determined at Block 358 that leasor does not want to relist the property, the property listing is removed from the database at Block 352, and the method is ended at Block 340.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system for negotiating pricing for a rental property, the system comprising:
a first client device in communication with a global communications network to be used by a prospective leasee of the rental property;
a second client device in communication with the global communications network to be used by a leasor of the rental property;
a server in communication with the first and second client devices via the global communications network; and
at least one database stored on a memory of the server, the at least one database including a memory having information stored thereon, the information relating to at least one of
attributes of the rental property,
attributes of the prospective leasee of the rental property, and attributes of the leasor of the rental property;
wherein the server is adapted to receive information from the first and second client devices to be stored on the at least one database and to be transmitted between the first and second client devices via the global communications network;
wherein the server is adapted to compare the information transmitted by at least one of the first client device and the second client device with the information stored on the at least one database;
wherein the server provides an indication to at least one of the first client device and the second client device indicating compatibility or non-compatibility of the information transmitted by at least one of the first client device and the second client device with the information stored on the at least one database.

2. A system according to claim 1 wherein the information stored on the at least one database relating to the attributes of the rental property is a minimum lease amount that the leasor of the rental property is willing to accept for the rental property; wherein the information transmitted by the first client device is an offer of a lease amount for the rental property; wherein compatibility of the information transmitted by the first client device is defined by the offer of the lease amount being equal to or exceeding the minimum lease amount for the rental property; and wherein non-compatibility of the information transmitted by the first client device is defined by the offer of the lease amount being less than the minimum lease amount for the rental property.

3. A system according to claim 1 wherein the information stored on the at least one database relating to the attributes of the rental property is a minimum lease amount that the leasor of the rental property is willing to accept for the rental property; wherein the information transmitted by the first client device is an offer of a lease amount for the rental property; wherein compatibility of the information transmitted by the first client device is defined by the offer of the lease amount being within a predetermined percentage of the minimum lease amount for the rental property; and wherein non-compatibility of the information transmitted by the first client device is defined by the offer of the lease amount not being within the predetermined percentage of the minimum lease amount for the rental property.

4. A system according to claim 1 wherein the information transmitted by the first client device is an offer of a lease amount for the rental property; wherein the server provides an indication to the second client device that an offer of a lease amount has been transmitted by the first client device; wherein the information transmitted by the second client device is an acceptance or a rejection of the offer; and wherein the server provides a notification to the first client device of the acceptance or rejection of the offer.

5. A system according to claim 4 wherein the information relating to the attributes of the rental property stored on the database includes a proposed lease for the rental property; and wherein the proposed lease is transmitted with the notification to the first client device of the acceptance of the offer.

6. A system according to claim 1 wherein the information relating to the attributes of the rental property stored on the database includes at least one of a proposed lease for the rental property and a lease application for the rental property; and wherein the proposed lease is viewable by the prospective leasee via the first client device.

7. A system according to claim 2 wherein the information relating to the attributes of the prospective leasee of the rental property includes payment information; and wherein the server automatically processes a lease application fee when the offer amount equals or exceeds the minimum lease amount.

8. A system according to claim 3 wherein the information relating to the attributes of the prospective leasee of the rental property includes payment information; and wherein the server automatically processes a lease application fee when the offer amount is within the predetermined percentage of the minimum lease amount.

9. A system according to claim 1 wherein the information relating to the attributes of the prospective leasee of the rental property includes payment information; and wherein the payment information includes at least one of a credit card number, banking information suitable for withdrawing funds from a bank account, a debit card number, and information suitable for withdrawing funds from a payment processing portal.

10. A system according to claim 1 wherein the server provides an indication to the leasor of the rental property after the information relating to the attributes of the rental property have been stored on the at least one database and viewable via the first client device.

11. A system according to claim 1 wherein the information relating to the attributes of the rental property include at least one of a deposit amount, and security amount to be paid by the prospective leasee; wherein the information relating to the attributes of the prospective leasee of the rental property include payment information; and wherein the server automatically processes a payment for at least one of the deposit amount and the security amount upon acceptance of an offer price for a lease amount for the rental property transmitted by the first client device to the second client device via the server.

12. A system according to claim 1 wherein the information transmitted by the first client device is at least one of a cancellation of a lease for the rental property and a withdrawal of a lease application; wherein the server transmits an indication of at least one of the cancellation of the lease and the withdrawal of the lease application to the second client device; and wherein at least one of the lease is cancelled and the lease application is withdrawn if the cancellation or withdrawal is transmitted from the first client device within a predetermined amount of time of entry into the lease.

13. A system according to claim 1 wherein the information relating to the attributes for the rental property includes a predetermined time that a minimum lease amount for the rental property will be accepted by the leasor of the rental property; and wherein the server provides a notification to the second client device after expiration of the predetermined time.

14. A method for using a system for negotiating pricing for a rental property, the system comprising first and second client devices in communication with a global communications network and in communication with a server, and at least one database stored on a memory of the server having information stored thereon relating to attributes of the real property, attributes of a prospective leasee of the rental property and attributes of a leasor of the rental property, the method comprising:
receiving information from the first and second client devices to be stored on the at least one database and to be transmitted between the first and second client devices via the global communications network;
comparing the information transmitted by at least one of the first and second client devices with the information stored on the at least one database; and
providing an indication to at least one of the first and second client devices of compatibility or non-compatibility of the information transmitted by at least one of the first and second client devices with the information stored on the at least one database.

15. A method according to claim 14 wherein the information stored on the at least one database is a minimum lease amount that the leasor of the rental property is willing to accept for the rental property; and further comprising transmitting an offer of a lease amount for the rental property from the first client device; wherein compatibility of the offer transmitted by the first client device is defined by the offer of the lease amount being equal to or exceeding the minimum lease amount for the rental property; and wherein non-compatibility of the offer transmitted by the first client device is defined by the offer of the lease amount being less than the minimum lease amount for the rental property.

16. A method according to claim 14 wherein the information stored on the at least one database is a minimum lease amount that the leasor of the rental property is willing to accept for the rental property; and further comprising transmitting an offer of a least amount for the rental property from the first client device; wherein compatibility of the offer transmitted by the first client device is defined by the offer of the lease amount being within a predetermined percentage of the minimum lease amount for the rental property; and wherein non-compatibility of the offer transmitted by the first client device is defined by the offer of the lease amount not being within the predetermined percentage of the minimum lease amount for the rental property.

17. A method according to claim 14 wherein the information transmitted by the first client device is an offer of a lease amount for the rental property, and further comprising:
providing an indication to the second client device that an offer of a lease amount has been transmitted by the first client device; and
transmitting an acceptance or a rejection of the offer; and
providing a notification to the first client device of the acceptance or rejection of the offer.

18. A method according to claim 17 wherein the information stored on the database includes at least one of a proposed lease for the rental property and a lease application for the rental property;; and further comprising transmitting at least one of the proposed lease for the rental property and the lease application for the rental property with the notification to the first client device of the acceptance of the offer.

19. A method according to claim 14 wherein the information stored on the database includes a proposed lease for the rental property; and further comprising displaying the proposed lease to the prospective leasee via the first client device.

20. A method according to claim 15 wherein the information relating to the attributes of the prospective leasee of the rental property includes payment information; and further comprising automatically processing a lease application fee when the offer amount equals or exceeds the minimum lease amount.

21. A method according to claim 16 wherein the information relating to the attributes of the prospective leasee of the rental property includes payment information; and further comprising automatically processing a lease application fee when the offer amount is within the predetermined percentage of the minimum lease amount.

22. A method according to claim 14 wherein the information relating to the attributes of the prospective leasee of the rental property includes payment information; and wherein the payment information includes at least one of a credit card number, banking information suitable for withdrawing funds from a bank account, a debit card number, and information suitable for withdrawing funds from a payment processing portal.

23. A method according to claim 14 further comprising providing an indication to the leasor of the rental property after the information relating to the attributes of the rental property have been stored on the at least one database and viewable via the first client device.

24. A method according to claim 14 wherein the information relating to the attributes of the rental property include at least one of a deposit amount, and security amount to be paid by the prospective leasee; wherein the information relating to the attributes of the prospective leasee of the rental property include payment information; and further comprising automatically processing a payment for at least one of the deposit amount and the security amount upon acceptance of an offer price for a lease amount for the rental property transmitted by the first client device to the second client device via the server.

25. A method according to claim 14 wherein the information transmitted by the first client device is at least one of a cancellation of a lease for the rental property and a withdrawal of a lease application for the rental property; and further comprising:
transmitting an indication at least one of the cancellation of the lease for the rental property and the lease application for the rental property to the second client device; and
cancelling at least one of the lease for the rental property and the lease application for the rental property if the indication is transmitted from the first client device within a predetermined amount of time at least one of entry into the lease and submitting the lease application.

26. A method according to claim 14 wherein the information relating to the attributes for the rental property includes a predetermined time that a minimum lease amount for the rental property will be accepted by the leasor of the rental property; and further comprising providing a notification to the second client device after expiration of the predetermined time.
